(19) United States
(12) Patent Application Publication
(10) Pub. No.: US 2009/0222298 A1
(43) Pub. Date: Sep. 3, 2009

(54) Data Mining Method for Automatic Creation of Organizational Charts

(75) Inventor: Susan Handayani Putri Atmaja, Singapore (SG)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/040,583

(22) Filed: Feb. 29, 2008

(51) Int. Cl. G06Q 10/00; G06F 17/30

(52) U.S. Cl. 705/7

(57) ABSTRACT

A computer implemented method, apparatus, and computer program product for generating organizational charts. The process receives a selection of an employee from an employee directory to form a reference employee. Thereafter, in response to receiving the selection, the process extracts information relating to a hierarchy of other employees with respect to the reference employee from an employee directory to form extracted information. The process then generates the organizational chart from the extracted information.

### BACKGROUND OF THE INVENTION

1. Field of the Invention

The present invention relates generally to an improved data processing system and in particular to a computer implemented method and apparatus for managing employee directory information. More particularly, the present invention is directed to a computer implemented method, apparatus, and computer usable program product for automatically generating an organizational chart from a set of profile data elements.

2. Description of the Related Art

An organizational chart is a type of chart that presents the hierarchy of an organization's employees in terms of rank. For example, this type of chart may show the relationships of managers and sub-workers who make up an organization. Organizational charts are useful in complex organizations where employees or third parties may need such a map to see the relationships between people and departments in an organization. Some benefits provided by organizational charts include reducing costs and increasing organizational effectiveness, eliminating communication barriers across organizational and physical boundaries, and leveraging the organization as a strategic resource to all of its members.

One currently used method for creating an organizational chart is having one or more people painstakingly analyze an organization's employee directory and manually collect desired biographical information on selected employees. The biographical information may include, for example, the employee's name, job description and category, the employee's manager, and the employee's staff. Similarly, biographical information may need to be collected for that employee's manager and for each staff member.

In many instances, only a subset of an organizations' employees are required for inclusion in an organizational chart. For example, a business proposal generated by a particular department may include within the proposal an organizational chart including only those members of the department responsible for creating the proposal. In generating the organizational chart, a reference employee is selected, such as the project manager of the department. A reference employee is an employee selected from an organization from which an organizational chart is derived. In other words, the reference employee serves as a point of reference for generating the organizational chart.

Thereafter, a chain of managers is identified from the reference employee. The chain of managers is one or more managers and is often defined in terms of a number of levels upward from the reference employee. For example, a chain of managers one level up from the reference employee includes the manager of the reference employee. A chain of managers two levels up from the reference employee includes the manager of the reference employee and the manager of the reference employee's manager.

Similarly, an organizational chart may include a chain of subordinates. A chain of subordinates is one or more employees managed by the reference employee. The chain of subordinates is typically defined in terms of a number of levels below the reference employee. For example, a chain of subordinates one level below the reference employee includes only those employees directly under the management of the reference employee. A chain of subordinates two levels below the reference employee includes those employees directly managed by the reference employee, as well as the employees managed by the employees managed by the reference employee.

Each manager of a chain of managers is located in a different manager level of an organizational hierarchy. A manager level is a level of an organizational hierarchy above a level that includes the reference employee. Similarly, each subordinate of a chain of subordinates is located on a subordinate level of an organizational hierarchy. A subordinate level is a level of an organizational hierarchy below a level that includes the reference employee.

For each employee included within an organizational chart, a set of profile data elements are collected. The set of profile data elements is biographical information for each employee. This information includes, for example, the department to which the employee belongs, the employee's job description, projects to which the employee has been assigned, a photograph of the employee, or any other biographical information that may be included in an employee directory.

Depending on the required scope of the organizational chart, the task could require one or more employees to manually locate and transcribe down biographical information on a large number of employees.

### BRIEF SUMMARY OF THE INVENTION

The illustrative embodiments described herein provide a computer implemented method, apparatus, and computer usable program product for generating organizational charts. The process receives a selection of an employee from an employee directory to form a reference employee. Thereafter, in response to receiving the selection, the process extracts information relating to a hierarchy of other employees with respect to the reference employee from an employee directory to form extracted information. The process then generates the organizational chart from the extracted information.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network data processing system in which illustrative embodiments may be implemented;

FIG. 2 is a block diagram of a data processing system in which the illustrative embodiments may be implemented;

FIG. 3 is a diagram of a data processing system for generating organizational charts from a set of profile data elements in accordance with an illustrative embodiment;

FIG. 4 is a block diagram of an employee directory page in accordance with an illustrative embodiment;

FIG. 5 is a diagram of a base uniform resource locator address pattern in accordance with an illustrative embodiment;

FIG. 6 is a diagram of a uniform resource locator pattern for identifying employee directory pages of managers in accordance with an illustrative embodiment;

FIG. 7 is diagram of a uniform resource locator pattern for identifying employee directory pages of subordinates in accordance with an illustrative embodiment;

FIG. 8 is a diagram of a pointer for identifying profile data elements in accordance with an illustrative embodiment;

FIG. 9 is a diagram of an organizational chart in accordance with an illustrative embodiment;

FIG. 10 is a flowchart of a process for generating an organizational chart from an employee directory in accordance with an illustrative embodiment; and

FIG. 11 is a flowchart of a process for extracting information from a set of employee directory pages in accordance with an illustrative embodiment.

### DETAILED DESCRIPTION OF THE INVENTION

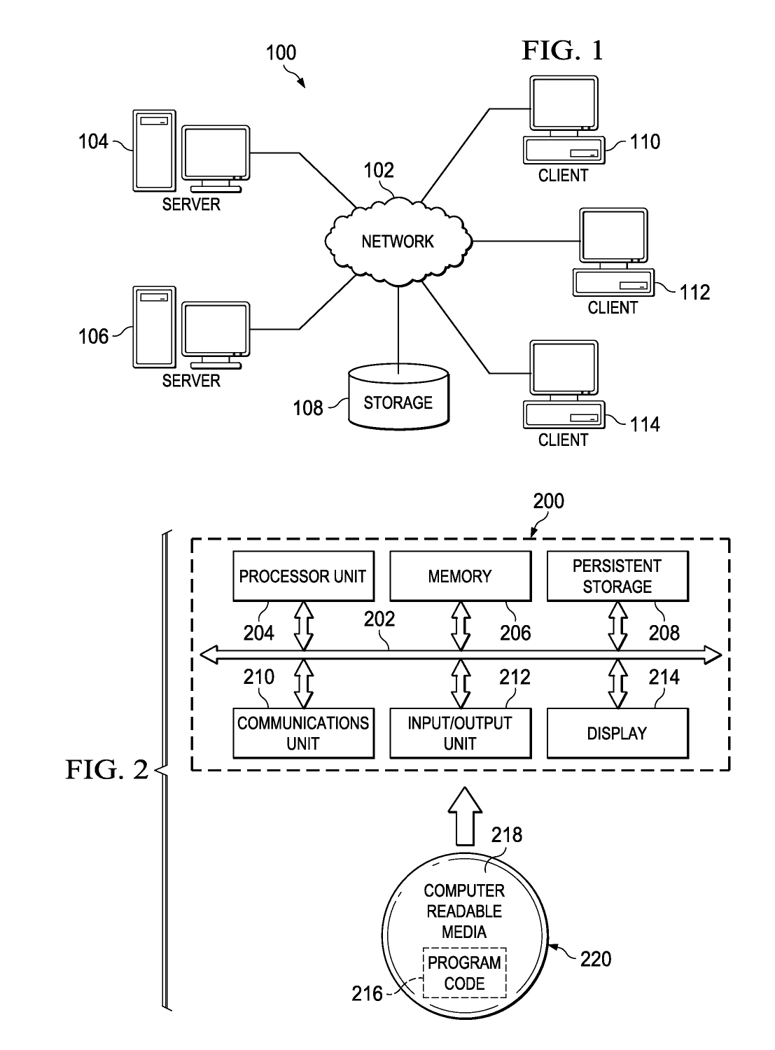

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing system in which illustrative embodiments may be implemented. Network data processing system 100 is a network of computing devices in which embodiments may be implemented. Network data processing system 100 contains network 102, which is the medium used to provide communications links between various devices and computers connected together within network data processing system 100. Network 102 may include connections, such as wire, wireless communications links, or fiber optic cables. The depicted example in FIG. 1 is not meant to imply architectural limitations. For example, data processing system 100 also may be a network of telephone subscribers and users.

In the depicted example, server 104 and server 106 connect to network 102 along with storage unit 108. In addition, clients 110, 112, and 114 are coupled to network 102. Clients 110, 112, and 114 are examples of devices that may be used to generate organizational charts from employee directory information. Directory information may be stored in storage unit 108 or in a server such as server 104. Communication between clients, servers, and networked storage units may occur over a network, such as network 102.

Clients 110, 112, and 114 may be, for example, a personal computer, a laptop, a tablet PC, a network computer, a hardwired telephone, a cellular phone, a voice over internet communications device, or any other communications device or computing device capable of transmitting and/or processing data. In the depicted example, server 104 provides data, such as boot files, operating system images, and applications to clients 110, 112, and 114. Clients 110, 112, and 114 are coupled to server 104 in this example. Network data processing system 100 may include additional servers, clients, computing devices, and other devices.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as, for example, an intranet, a local area network (LAN), a wide area network (WAN), a telephone network, or a satellite network. FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, memory 206 or a cache. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

Organizational charts are useful for presenting the hierarchical structure of an organization's employees. Current methods for deriving organizational charts involve one or more of an organizations' employees searching an employee directory for locating employee directory pages associated with a reference employee. Usually, the search progresses by locating a reference employee. Then, the searcher manually navigates to other associated employee directory pages. From each employee directory page, the searcher locates profile data for inclusion in the organizational chart. However, this method of generating organizational charts is time consuming and inefficient, particularly for large organizations where the organizational chart is the most effective. Therefore, a novel method for performing this task quickly and efficiently, with the least amount of user input is preferred.

The illustrative embodiments described herein provide a computer implemented method, apparatus, and computer usable program product for generating organizational charts. The process receives a selection of an employee from an employee directory to form a reference employee. A reference employee is an employee selected from an organization from which an organizational chart is derived. In other words, the reference employee serves as a point of reference when generating the organizational chart. For example, the scope of an organizational chart may be defined as including all those employees located on two manager levels above the reference employee. Similarly, the organizational chart may be defined as including all those employees located on two subordinate levels below the reference employee.

Thereafter, in response to receiving the selection, the process extracts information relating to a hierarchy of other employees with respect to the reference employee from an employee directory to form extracted information. The extracted information comprises a set of uniform resource locator patterns. The process then generates the organizational chart from the extracted information

As used herein, a set means one or more. For example, a set of uniform resource locator patterns is one or more uniform resource locator patterns.

After identifying a set of uniform resource locator patterns, the process locates a set of directory pages associated with the employee directory page for the reference employee using the set of identified uniform resource locator patterns. In one embodiment, the process locates the set of directory pages using a breadth first searching algorithm. In an alternate embodiment, the process locates the set of directory pages using a depth first searching algorithm. However, in other embodiments, any search algorithm may be implemented.

The process then generates the organizational chart from a set of employee directory pages associated with the employee directory page for the reference employee. The organizational chart may take the form of a tree data structure. In this example, each node of the tree data structure represents an employee directory page from the set of employee directory pages associated with the directory page of the reference employee.

In one embodiment, a set of profile data elements incorporated into the organizational chart, are selected by a user. In an alternate embodiment, a user's selection of a particular organizational chart template defines the set of profile data elements that are incorporated into the organizational chart.

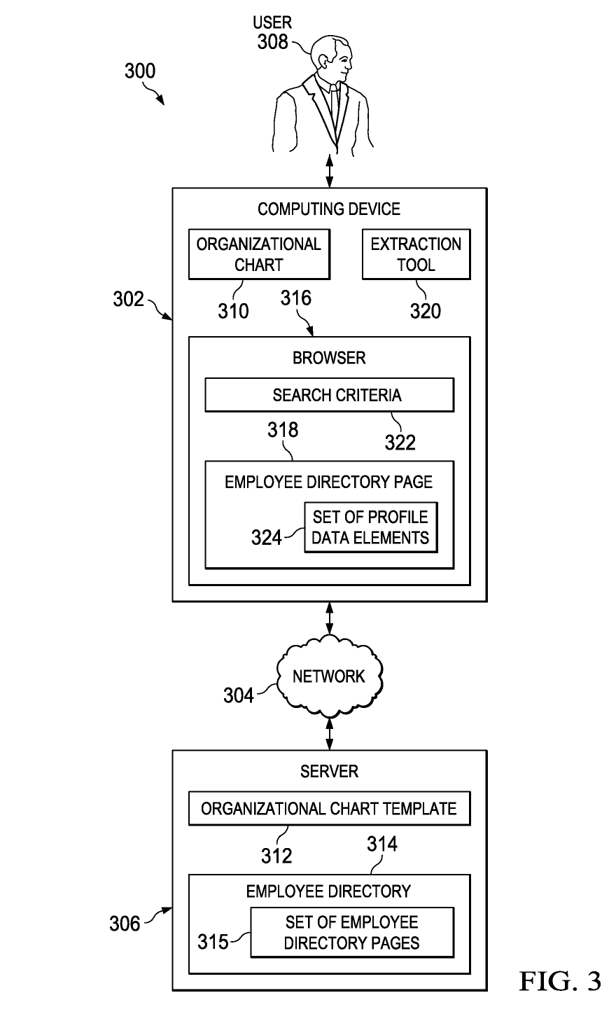

FIG. 3 is a block diagram of a data processing system for generating organizational charts from a set of profile data elements in accordance with an illustrative embodiment. Data processing system 300 is a data processing system, such as data processing system 100 in FIG. 1. Data processing system 300 includes computing device 302, network 304, and server 306. Computing device 302, network 304, and server 306 are data processing system elements, such as client 110, network 102, and server 104, respectively, in FIG. 1.

User 308 operates computing device 302 for generating organizational chart 310. Organizational chart 310 is a chart depicting a corporate hierarchy of the employees of an organization. Organizational chart 310 may be in the form of a tree structure and include profile data included within an organization's employee directory. Profile data is data maintained by an organization which is related to a particular employee. Profile data includes, for example, employee names, employee identification numbers, job descriptions, contact information, photographs, experience, or any other employee-related information that may be maintained by an organization. Profile data may also include data identifying a selected employee's manager or the subordinate employees managed by the selected employee.

The formatting of organizational chart 310 is determined according to organizational chart template 312. Organizational chart template 312 is a set of pre-designed formats for text and/or graphics that may be applied to organizational chart 310. User 308 may select a chart template from organizational chart template 312 for application to organizational chart 310 to control the manner in which organizational chart 310 is presented. In this example, organizational chart template 312 is stored in server 306 along with employee directory 314.

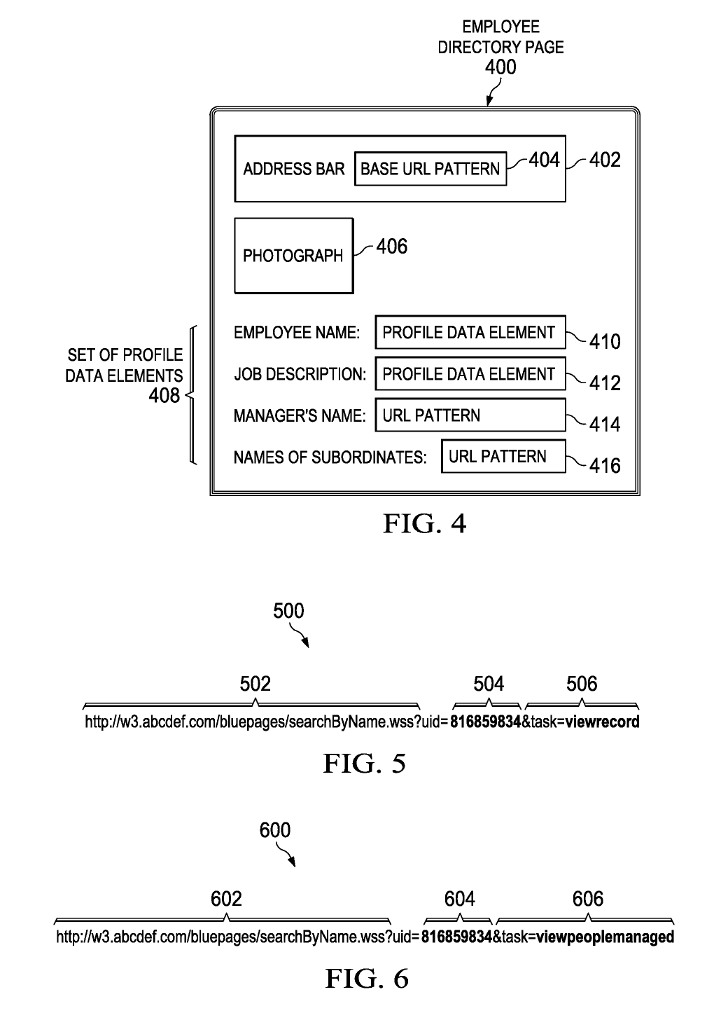

The profile data included within organizational chart 310 is maintained within employee directory 314. Employee directory 314 is a collection of employment records for the employees of an organization. In particular, employee directory 314 includes set of employee directory pages 315. Set of employee directory pages 315 is one or more records storing profile data that is used for generating organizational chart 310. Set of employee directory pages 315 may be presented in any type of format. For example, set of employee directory pages 315 may be formatted as a web page, as depicted in FIG. 4. However, set of employee directory pages 315 may take other forms, such as, for example, a collection of tables in employee directory 314.

Employee directory 314 may be a database of employee records. Employee directory 314 may be accessed by a user, such as user 308, for locating an employee directory page for a selected employee based on any number of criteria. The criteria may include employee name, job rank, department, experience, or any other type of information that may be maintained within employee directory 314.

User 308 may access employee directory 314 via browser 316. Browser 316 is a software application used to search a collection of data in a network data processing system. This type of application may enable user 308 to display and interact with collections of data, such as text, images, videos, music, and other information. This information may be presented by browser 316 over a network, such as the Internet or a local area network. Browser 316 may be, for example, Mozilla Firefox®, Internet Explorer®, and Netscape Navigator®. Mozilla Firefox is a registered trademark of Mozilla Corporation. Internet Explorer is a registered trademark of Microsoft Corporation. Netscape Navigator is a registered trademark of Netscape Communications Corporation.

Information related to a particular employee of an organization is presented to user 308 on browser 316. In particular, the information is presented on employee directory page 318. In one embodiment, employee directory page 318 is a hypertext markup language (HTML) webpage generated from an employee's profile data stored in employee directory 314. A sample employee directory page is presented in FIG. 4. Employee directory page 318 presents set of profile data elements 324 relating to a particular user. Set of profile data elements 324 is one or more data types selected from employee directory page 318. Set of profile data elements 324 includes, for example, an employee's name, job description, the name of the employee's manager, and names of subordinates.

Each profile data element from set of profile data elements 324 is associated with a pointer that identifies the type of information with which the pointer is associated. In one embodiment, the pointer is a set of hypertext markup language tags. For example, set of profile data elements 324 may include an employee's name. A hypertext markup language tag associated with the employee's name identifies that profile data element as the name of an employee. Extraction tool 320 identifies a profile data element from an employee directory page by finding the pointer identifying the data type. An example of a pointer is presented in FIG. 8.

Employee directory page 318 may also be formatted to include a series of links that user 308 may select to navigate to other employee directory pages. For example, a link may enable user 308 to navigate to an employee directory page of a manager of the employee whose profile information is presented on employee directory page 318. Similarly, employee directory page 318 may include a link that may be selected to redirect user 308 to a page identifying the subordinate employees managed by the employee described in employee directory page 318. Each link displayed on employee directory page 318 comports with a specific uniform resource locator pattern. Examples of uniform resource locator patterns are presented in more detail in FIGS. 5, 6, and 7. The existence of specific uniform resource locator patterns facilitates the searching of employee directory 314 by extraction tool 320 in the manner described in more detail below.

Extraction tool 320 is a software program and generates organizational chart 310 from data contained within employee directory 314. An extraction tool is a software application capable of searching an employee directory for a set of profile data elements. The set of profile data elements are then used to generate the organizational chart. In an illustrative embodiment, an extraction tool may search an employee directory using a breadth first search algorithm. In an alternate embodiment, the extraction tool may implement a depth first search algorithm.

Extraction tool 320 receives input generated by user 308 using browser 316. The input may include, for example, search criteria 322. Search criteria 322 is criteria defining the scope of the search of employee directory 314. Search criteria 322 may specify, for example, at least one of a number of manager levels up from a reference employee, or a number of subordinate levels below the reference employee. In other words, search criteria 322 may specify either a number of manager levels, a number of subordinate levels, or both.

An organizational chart may be thought of as a series of levels or tiers with employees having similar hierarchical ranks on the same level. An example of an organizational chart is provided in FIG. 9.

An organizational hierarchy may have multiple manager levels. For example, a reference employee will have a manager located on one manager level above. Likewise, the reference employee's manager will have a manager located on two manager levels above the reference employee. Similarly, the selected employee may also manage one or more subordinates. Those subordinate employees are located on one subordinate level below the reference employee. Each subordinate employee may also manage one or more subordinate employees who are then located on two subordinate levels below the reference employee. Thus, specifying a number of manager levels up or number of subordinate levels down from a reference employee, user 308 is able to limit the scope of the search of employee directory 314.

In one embodiment, user 308 manually inputs values for search criteria 322 into browser 316. In an alternate embodiment, search criteria 322 may be provided automatically when user 308 selects a particular template from organizational chart template 312. For example, search criteria 322 and/or organizational chart template 312 may specify that an organizational chart 310 shall include an employee's photograph, title, and job description. In addition, search criteria 322 and/or organizational chart template 312 may specify that such profile data shall be collected for all employees located up two manager levels and down two subordinate levels. Extraction tool 320 may use this information to limit the scope of the search of employee directory 314.

Extraction tool 320 navigates through the various employee directory pages that form employee directory 314 by processing the uniform resource locator patterns identified by user 308. For example, user 308 may identify a link on employee directory page 318 as redirecting a user to a directory page of the manager of the employee described in employee directory page 318. The user may identify the link in any known or later developed manner. For example, the link may be highlighted by a cursor and identified by a menu option accessible by clicking on a right mouse button. Alternatively, the user may select a checkbox beside the link. Any selection method may be implemented.

Once identified, extraction tool 320 stores and processes the uniform resource locator pattern associated with the selected link. Thereafter, if search criteria 322 specifies that organizational chart 310 shall include information for employees two manager levels above a reference employee identified in employee directory page 318, then extraction tool 320 will automatically navigate to the employee directory pages for the managers on each of the two manager levels above the reference employee. In one example, extraction tool 320 navigates to the employee directory page for the manager one level above the reference employee. Extraction tool 320 may then proceed to the employee directory page for the manager two manager levels above the reference employee by following the uniform resource locator pattern located on the employee directory page for the manager one manager level above the selected employee. In a similar manner, extraction tool 320 may navigate to the employee directory pages for each subordinate employee under the reference employee.

Uniform resource locator patterns are suppressed when information is sent via a hypertext transfer protocol POST protocol. Thus, in an embodiment where a POST protocol is implemented, extraction tool 320 monitors the hypertext transfer protocol data stream to identify the uniform resource locator patterns usable to navigate employee directory 314.

Before proceeding to another employee directory page, extraction tool 320 may collect the information defined by set of profile data elements 324. User 308 selects from employee directory page 318 the profile data elements that form set of profile data elements 324. Alternatively, the profile data elements may be pre-selected according to the chart template of organizational chart template 312 selected by user 308. Set of profile data elements 324 may be specified by the hypertext markup language tags included within the source code of an employee directory page. Thus, upon navigating to an employee directory page for an upper level manager, extraction tool 320 collects profile data elements for that manager specified by set of profile data elements 324. The profile data elements are located on a particular employee directory page by locating the appropriate hypertext markup language tags.

Extraction tool 320 may search employee directory 314 using any available method or process. For example extraction tool 320 may search employee directory 314 using a breadth first search algorithm. A breadth first search algorithm is a process that begins at a root node and progresses outward from the root node and explores all the neighboring nodes. Then for each of those nearest nodes, the algorithm explores their unexplored neighbor nodes, and so on, until a goal is attained. In the context of searching employee directory 314, the root node correlates with a selected employee having an employee directory page identified by a base uniform resource locator address. The base uniform resource locator address will be described in more detail below. In addition, the specified goal would be a number of manager levels above and subordinate levels below the root node.

In another embodiment, extraction tool 320 may search employee directory 314 using a depth first algorithm. A depth first search algorithm proceeds by expanding successive children from a root node until a goal node is found, or until it hits a node that has no children. Extraction tool 320 implementing a depth first search algorithm then backtracks, returning to the most recent node having children nodes.

In an illustrative embodiment, extraction tool 320 receives a selection of an employee from an employee directory. This selection identifies a reference employee. In a non-limiting embodiment, extraction tool 320 receives the selection of the employee when user 308 inputs a base uniform resource locator address for the reference employee. User 308 may input the base uniform resource locator address in browser 316. For example, user 308 may provide the base uniform resource locator address by typing the uniform resource locator address into an address bar. Alternatively, user 308 may located employee directory page 318 from employee directory 314 and input the base uniform resource locator address by selecting a menu option.

Browser 316 returns employee directory page 318 associated with the base uniform resource locator address provided by user 308. User 308 then provides search criteria 322 to extraction tool 320 via browser 316. In addition, user 308 selects profile data elements from employee directory page 318 to form set of profile data elements 324.

Thereafter, extraction tool 320 extracts information relating to a hierarchy of other employees with respect to the reference employee to form extracted information. Information relating to the hierarchy of other employees with respect to the reference employee is information identified for inclusion in an organizational chart. The information may be identified by user 308 by selecting profile data elements presented in employee directory page 318. Alternatively, the information may be identified by an organizational chart template selected by user 308. This information includes, for example, identification of managers and subordinates, job descriptions, employee names, set of profile data elements 324, and any other type of information that may be stored within employee directory 314.

Set of profile data elements 324 includes a set of uniform resource locator patterns. The set of uniform resource locator patterns directs extraction tool 320 to the employee directory pages of the other employees included within organizational chart 310. Once extraction tool 320 has navigated to the employee directory pages of the other employees, extraction tool 320 collects profile data elements. Extraction tool 320 then formats the collected information according to organizational chart template 312 to form organizational chart 310.

FIG. 4 is an illustration of an employee directory page in accordance with an illustrative embodiment. Employee directory page 400 is an example of an employee directory page, such as employee directory page 318 in FIG. 3.

Employee directory page 400 includes address bar 402. Address bar 402 is a field in which a user may provide a base uniform resource locator pattern for a particular employee directory page. In this illustrative example in FIG. 4, a user provides base uniform resource locator pattern 404 to obtain employee directory page 400. A more detailed description of a base uniform resource locator pattern is provided with reference to FIG. 5 below.

Employee directory page 400 includes photograph 406 of the employee described by employee directory page 400. In addition, employee directory page 400 includes set of profile data elements 408. Set of profile data elements 408 includes an employee's name, job description, the name of the employee's manager, and names of subordinates.

Profile data element 410 is the name of the employee described in employee directory page 400. Profile data element 410 may be an alphanumeric string of text. Profile data element 412 is an alphanumeric string of text describing the selected employee's job description.

Uniform resource locator pattern 414 is a uniform resource locator pattern identifying an employee directory page for the selected employee's manager. Similarly, uniform resource locator pattern 416 is a uniform resource locator pattern identifying one or more employee directory pages of subordinates managed by the selected employee described by employee directory page 400. Uniform resource locator patterns 414 and 416 may be navigable links that, if selected, redirects a user to a different employee directory page.

A user, such as user 308 in FIG. 3, may generate set of profile data elements 408 by selecting or identifying any one or more profile data elements displayed on employee directory page 400, or by selecting an organizational chart template, such as organizational chart template 312 in FIG. 3.

FIG. 5 is a diagram of a base uniform resource locator pattern in accordance with an illustrative embodiment. Base uniform resource locator 500 may be specified by a user when the user types in an address in the address bar of a browser. Alternatively, base uniform resource locator pattern 500 may be identified by a user by selecting a menu option accessible to a user while viewing an employee directory page associated with base uniform resource locator pattern 500.

Base uniform resource locator pattern 500 includes root address 502, employee identification number 504, and action 506. Root address 502 identifies the employee directory in which the associated employee directory page is located. Employee identification number 504 identifies the employee described by the employee directory page. Action 506 identifies the action that occurs when base uniform resource locator pattern 500 is entered into a browser or used for navigating an employee directory. Thus, when base uniform resource locator pattern 500 is entered into an address bar, a browser returns the associated employee directory page to a user for viewing.

An extraction tool, such as extraction tool 320 in FIG. 3, may identify the parts of base uniform resource locator 500 for use in generating an organizational chart, such as organizational chart 310 in FIG. 3. For example, the extraction tool may identify the returned employee directory page as a root node. Consequently, the extraction tool can perform a search of an employee directory for managers and/or subordinates using the root node as a reference point.

FIG. 6 is a diagram of a uniform resource locator pattern for identifying employee directory pages of managers in accordance with an illustrative embodiment. Uniform resource locator pattern 600 is a uniform resource locator address specifying an employee directory page for the subordinates managed by the employee described in an employee directory page. Uniform resource locator pattern 600 includes root 602, employee identification number 604, and action 606. Root address 602 identifies the employee directory in which the associated employee directory page is located. Employee identification number 604 identifies the employee described by the employee directory page. Action 606 identifies the action that occurs. Thus, when uniform resource locator pattern 600 is selected from an employee directory page, a browser redirects the user to the subordinates managed by the user described in the employee directory page.

A user selects or otherwise identifies uniform resource locator pattern 600 to enable an extraction tool, such as extraction tool 320 in FIG. 3, to store the uniform resource locator pattern that would enable the extraction tool to navigate to the employee directory page(s) of the one or more subordinates managed by the employee described in the employee directory page.

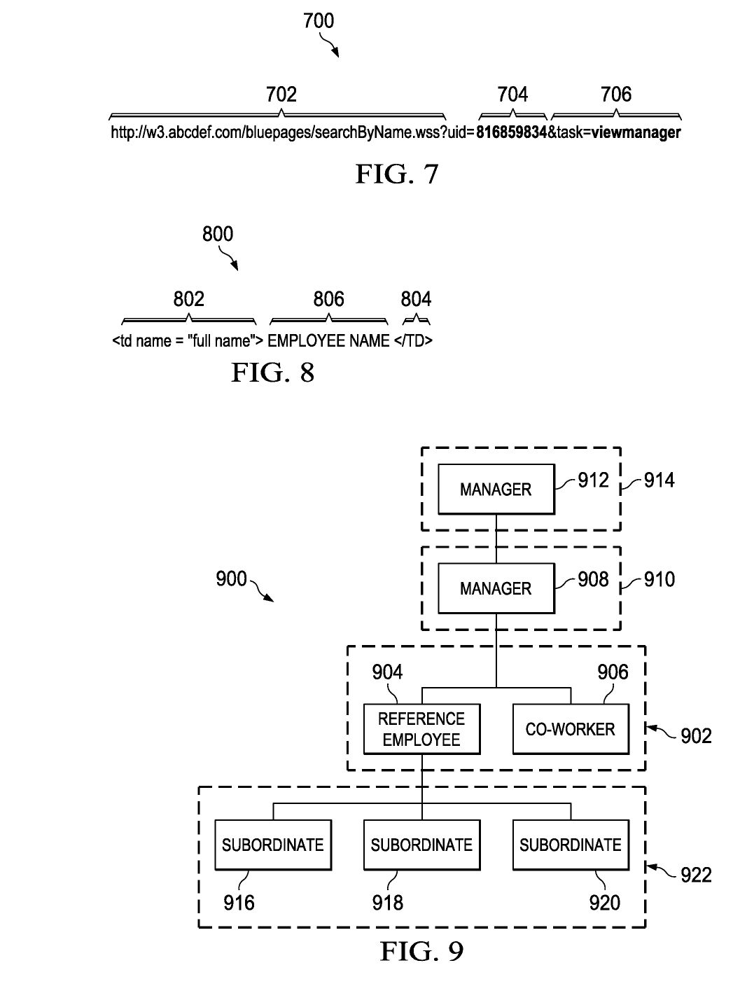

FIG. 7 is a diagram of a uniform resource locator pattern for identifying employee directory pages of subordinates in accordance with an illustrative embodiment. Uniform resource locator pattern 700 is a uniform resource locator address specifying an employee directory page for a manager of the employee described in an employee directory page. Uniform resource locator pattern 700 includes root address 702, employee identification number 704, and action 706. Root address 702 identifies the employee directory in which the associated employee directory page is located. Employee identification number 704 identifies the employee described by the employee directory page. Action 706 identifies the action that occurs. Thus, when uniform resource locator pattern 700 is selected from an employee directory page, a browser redirects the user to the manager of the user described in the employee directory page.

A user selects or otherwise identifies uniform resource locator patter 700 to enable an extraction tool, such as extraction tool 320 in FIG. 3, to store the uniform resource locator pattern that would enable the extraction tool to navigate to the employee directory page of the managers of the employee described in the employee directory page.

FIG. 8 is a diagram of a pointer that identifies profile data elements in accordance with an illustrative embodiment. Pointer 800 is a pointing mechanism that identifies elements of a set of profile data elements. Pointer 800 includes a set of hypertext markup language tags. The set of hypertext markup language tags includes opening tag 802 and closing tag 804. Opening tag 802 is a hypertext markup language tag that identifies the type of information associated with a set of hypertext markup language tags. In this example, opening tag 802 identifies the information type 806 as an employee's full name. Closing tag 804 is a hypertext markup language tag that indicates the end of information type 806. The set hypertext markup language tags in FIG. 8 are incorporated into the source code of an employee directory page, such as employee directory page 400 in FIG. 4.

In this illustrative example in FIG. 8, hypertext markup language tag 800 identifies an employee's name. However, in alternate embodiments, a hypertext markup language tag may be used to identify any one of a set of profile data elements, such as profile data elements 408 in FIG. 4.

Hypertext markup language tag 800 may be used by an extraction tool, such as extraction tool 320 in FIG. 3, to locate employee names in other employee directory pages from a set of employee directory pages.

FIG. 9 is a diagram of an organizational chart in accordance with an illustrative embodiment. Organizational chart 900 includes reference level 902. Reference level 902 is a level of organizational chart 900 that includes reference employee 904. Levels of an organizational chart include employees having the same or similar positions in the organizational hierarchy. Reference employee 904 is an employee that correlates with a base uniform resource locator pattern, such as base uniform resource locator pattern 500 in FIG. 5. Reference level 902 also includes co-worker 906 that shares a common manager with reference employee 904.

Organizational chart 900 also includes manager 908 located in first manager level 910. Manager 908 is the manager directly over reference employee 904. Organizational chart 900 also includes manager 912 located in second manager level 914. Manager levels are identified from the data stored within an employee directory, such as employee directory 314 in FIG. 3. In particular, manager levels are identified for a chain of managers from a uniform resource locator pattern selected by a user from an employee directory page of a reference employee. For example, a first manager level is identified by an extraction tool, such as extraction tool 320 in FIG. 3, when the extraction tool navigates to an employee directory page of a manager of reference employee 904. The same uniform resource locator pattern is used by the extraction tool to identify each successive manager and manager level in the chain of managers.

Organizational chart 900 also includes subordinates 916, 918, and 920. Subordinates 916, 918, and 920 are employees managed by reference employee 904 and located in subordinate level 922. Subordinate levels of organizational chart 900 are identified in the same manner in which manager levels are identified.

Organizational chart 900 may be generated by an extraction tool if the related search criteria for reference employee 904 included two management levels up from reference level 902. In addition, the search criteria may specify one or two subordinate levels below the reference level. In this example, if none of subordinates 916, 918, or 920 managed any other employees, then an extraction tool would generate organizational chart 900 despite the fact that a user may have selected a template or search criteria specifying two subordinate levels below the reference level 902.

In another embodiment, organizational chart 900 may also show a chain of subordinates of either manager 912, manager 908, or co-worker 906 provided the chain of subordinates comports with selected search criteria identified with respect to reference employee 904. For example, if search criteria requests that an organizational chart be generated having two subordinate levels from reference level 902, then a chain of subordinates identified for co-worker 906 may be displayed to the extent that the chain of subordinates does not exceed the two subordinate levels identified in the search criteria identified with respect to reference employee 904.

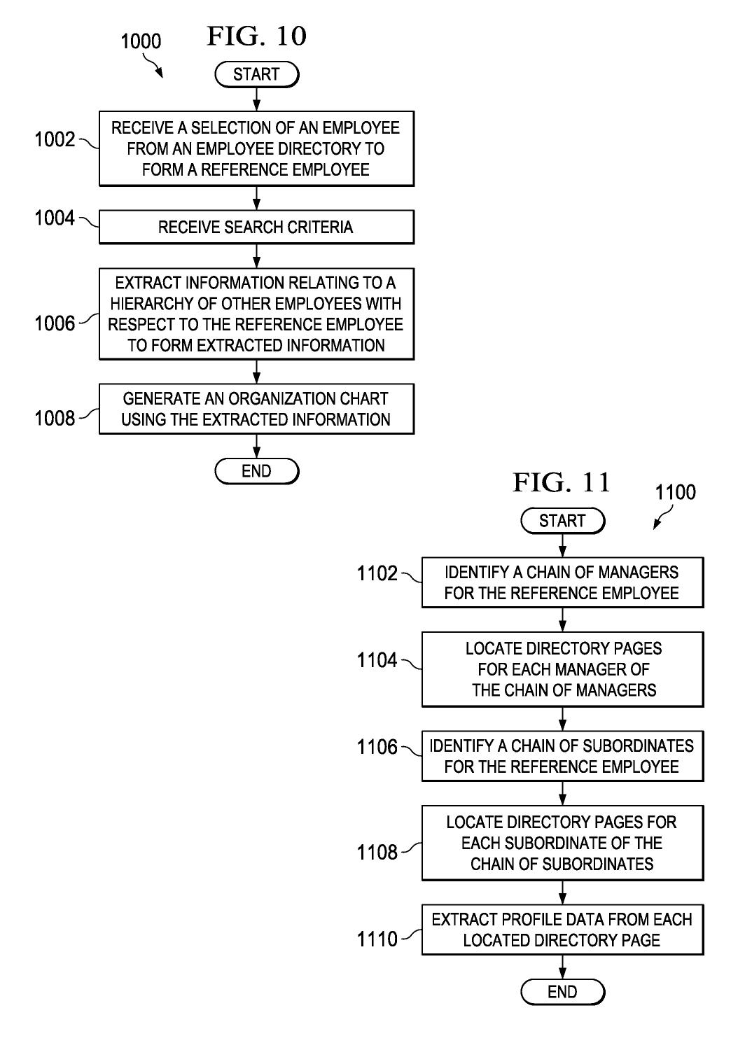

FIG. 10 is a flowchart of a process for generating an organizational chart from an employee directory in accordance with an illustrative embodiment. The process may be performed by a software component, such as extraction tool 320 in FIG. 3.

The process begins by receiving a selection of an employee from an employee directory to form a reference employee (step 1002). The process then receives search criteria (step 1004). Thereafter, the process extracts information relating to a hierarchy of other employees with respect to the reference employee to form extracted information (step 1006).

The process then generates the organizational chart using the extracted information (step 1008). The process terminates thereafter.

FIG. 11 is a flowchart of a process for extracting information from a set of employee directory pages in accordance with an illustrative embodiment. The process may be performed by software, such as extraction tool 320 in FIG. 3.

The process begins by identifying a chain of managers for the reference employee (step 1102). The process then locates directory pages for each manager of the chain of managers (step 1104). The process may locate these directory pages by analyzing a uniform resource locator pattern from a directory page of a reference employee.

The process then identifies a chain of subordinates for the reference employee (step 1106). The process then locates directory pages for each subordinate of the chain of subordinates (step 1108). Thereafter, the process extracts profile data from each located directory page (step 1110) and terminates thereafter.

The flowcharts and block diagrams in the different depicted embodiments illustrate the architecture, functionality, and operation of some possible implementations of methods, apparatus, and computer usable program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The illustrative embodiments described herein provide a computer implemented method, apparatus, and computer usable program product for generating organizational charts. The process receives a selection of an employee from an employee directory to form a reference employee. Thereafter, in response to receiving the selection, the process extracts information relating to a hierarchy of other employees with respect to the reference employee from an employee directory to form extracted information. The process then generates the organizational chart from the extracted information.

Thus, the method and apparatus discussed above obviates the need to have one or more employees manually search an employee directory for a chain of managers and subordinates. The simple selection of the set of profile data elements from a directory page for a reference employee enables the process to automatically locate a set of employee directory pages for those employees that will form the organizational chart. In addition, the process is capable of automatically extracting a set of profile data elements from each directory page from the set of employee directory pages. Consequently, time and human resources are preserved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating an organizational chart, the computer implemented method comprising:
receiving a selection of an employee from an employee directory to form a reference employee;
responsive to receiving the selection, extracting information relating to a hierarchy of other employees with respect to the reference employee from the employee directory to form extracted information; and
generating the organizational chart from the extracted information.

2. The computer implemented method of claim 1, further comprising:
storing the selection of a set of profile data elements from an employee directory page.

3. The computer implemented method of claim 1, wherein the storing step further comprises:
associating each profile data element in the set of the profile data elements with a hypertext markup language tag.

4. The computer implemented method of claim 1, further comprising:
receiving a set of search criteria, wherein the search criteria comprises at least one of a selection of manager levels and a selection of subordinate levels.

5. The computer implemented method of claim 1, further comprising:
extracting the set of profile data elements from each page of a set of directory web pages.

6. The computer implemented method of claim 1, wherein the extracted information comprises a set of uniform resource locator patterns.

7. The computer implemented method of claim 1, wherein the extracted information is gathered by data mining process of the employee directory.

8. The computer implemented method of claim 7, wherein the data mining uses at least one of a depth first search algorithm and a breadth first search algorithm.

9. The computer implemented method of claim 1, wherein the hierarchy of the other employees comprises a set of employees that form a business unit of the organization.

10. A computer program product comprising:
computer usable medium including computer usable program code for generating organizational charts, the computer program product comprising:
computer usable program code for receiving a selection of an employee from an employee directory to form a reference employee;
computer usable program code for extracting information relating to a hierarchy of other employees with respect to the reference employee from the employee directory to form extracted information in response to receiving the selection; and
computer usable program code for generating the organizational chart from the extracted information.

11. The computer program product of claim 10, further comprising:
computer usable program code for storing the selection of a set of profile data elements from an employee directory page.

12. The computer program product of claim 11, wherein the computer usable program code for the storing step further comprises:
computer usable program code for associating each profile data element of the set of the profile data elements with a hypertext markup language tag.

13. The computer program product of claim 10, further comprising:
computer usable program code for receiving a set of search criteria, wherein the search criteria comprises at least one of a selection of manager levels and a selection of subordinate levels.

14. The computer program product of claim 10, further comprising:
computer usable program code for extracting the set of profile data elements from each page of a set of directory web pages.

15. The computer program product of claim 14, wherein the extracted information comprises a set of uniform resource locator patterns.

16. The computer program product of claim 10, wherein the extracted information is gathered by data mining of the employee directory.

17. The computer program product of claim 16, wherein the data mining uses at least one of a depth first search algorithm and a breadth first search algorithm.

18. An apparatus for generating organizational charts, the apparatus comprising:
a bus system;
a memory connected to the bus system, wherein the memory includes computer usable program code; and
a processing unit connected to the bus system, wherein the processing unit executes the computer usable program code to receive a selection of an employee from an employee directory to form a reference employee; extract information relating to a hierarchy of other employees with respect to the reference employee from the employee directory to form extracted information in response to receiving the selection, wherein the extracted information comprises a set of uniform resource locator patterns; and generate the organizational chart from the extracted information.

19. The apparatus of claim 18, wherein the processing unit further executes the computer usable program code to store the selection of the set of profile data elements from an employee directory page, wherein storing a selection further comprises associating each profile data element in a set of the profile data elements with a hypertext markup language tag.

20. An apparatus comprising:
an employee directory comprising a set of employee directory web pages, wherein the employee directory web pages store a set of profile data elements relating to employees of an organization; and
an extraction tool, wherein the extraction tool receives a selection of an employee from the employee directory to form a reference employee; extracts information relating to a hierarchy of other employees with respect to the reference employee from the employee directory to form extracted information in response to receiving the selection; and generates the organizational chart from the extracted information.
